(19) United States
(12) Patent Application Publication
(10) Pub. No.: US 2010/0148485 A1
(43) Pub. Date: Jun. 17, 2010

(54) MULTIPLE PAGE ARTICLE OR BOOKLET

(76) Inventor: Michael H. Gaughan, Montgomery, MN (US)

Correspondence Address: WESTMAN CHAMPLIN & KELLY, P.A., SUITE 1400, 900 SECOND AVENUE SOUTH, MINNEAPOLIS, MN, 55402, US

(21) Appl. No.: 12/635,356

(22) Filed: Dec. 10, 2009

Related U.S. Application Data
(60) Provisional application No. 61/122,134, filed on Dec. 12, 2008.

(51) Int. Cl. B42D 1/00; B42C 9/00; B42D 3/00

(52) U.S. Cl. 281/21.1; 412/8; 281/29

(57) ABSTRACT

A multiple page article or booklet is disclosed. As disclosed, the multiple page article or booklet includes a plurality of staggered edges providing one or more generally flat staggered edges surfaces. An adhesive band is provided along the staggered edges or staggered edge surfaces to form a seam connecting pages of the multiple page article or booklet.

### CROSS-REFERENCE TO RELATED APPLICATION

The present application claims the benefit of and priority to U.S. provisional patent application Ser. No. 61/122,134, filed Dec. 12, 2008, the content of which is hereby incorporated by reference in its entirety.

### BACKGROUND

Multiple page booklets have a wide range of applications. For example, multiple page booklets or leaflets can be used to provide product information or instructions. In some applications, the multiple page booklet or leaflet is illustratively attached to products directly or to product packaging. In today's economy, consumers demand lower prices and product leaflets or booklets add cost. The discussion above is merely provided for general background information and is not intended to be used as an aid in determining the scope of the claimed subject matter.

### SUMMARY

The present application relates to a multiple page article or booklet. As disclosed, the multiple page article or booklet includes a plurality of staggered edges providing one or more generally flat staggered edges surfaces. In embodiments disclosed, the multiple page article or booklet includes an adhesive band along the staggered edges or edge surfaces to form a seam connecting pages of the multiple page article or booklet.

Other features and embodiments of the present application are disclosed in the detailed description and illustrative figures of the application. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a schematic illustration of an embodiment of a multiple page article or booklet of the present application.

FIG. 2 is a schematic illustration of the multiple page article or booklet of FIG. 1 shown open to a specific page.

FIG. 3 is a cross-sectional view of an embodiment of a multiple page article or booklet as shown in FIGS. 1-2.

FIG. 4 illustrates process steps for forming the multiple page article or booklet of FIG. 1.

FIG. 5A is a cross-sectional view of an embodiment of the multiple page article or booklet having adhesive strips.

FIG. 5B is a cross-sectional view of the embodiment illustrated in FIG. 5A with the releasable backing layer removed to attach the multiple page article or booklet to a separate article or container.

FIG. 6 is a cross-sectional view of another embodiment of a multiple page article or booklet including an adhesive strip along one side of the multiple page article or booklet.

FIG. 7 is a cross-sectional view of an embodiment of a multiple page article or booklet including an adhesive layer or strip on a reverse side of a base sheet.

FIG. 8 illustrates an embodiment including a plurality of multiple page articles or booklets provided on a continuous web or support.

FIG. 9 is a plan view of a foldable sheet for forming multiple pages of the article or booklet.

FIG. 10 is a schematic illustration of the foldable sheet of FIG. 9 shown partially folded.

FIG. 11 is a schematic illustration of the foldable sheet of FIG. 9 shown having inner foldable segments folded on top of a base segment.

FIG. 12 illustrates process steps for forming the multiple page article or booklet from the foldable sheet as illustrated in FIGS. 9-11.

### DETAILED DESCRIPTION OF ILLUSTRATIVE EMBODIMENTS

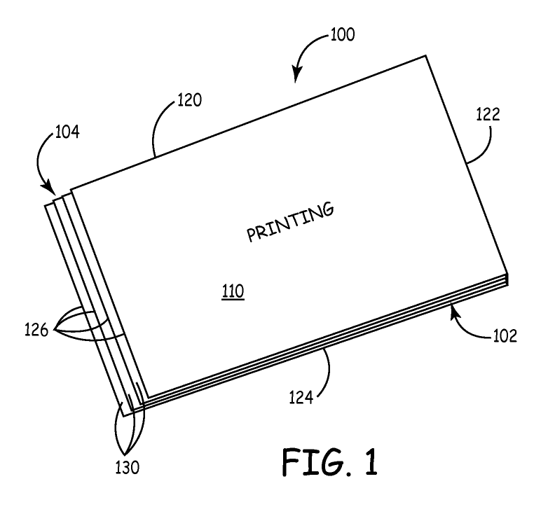

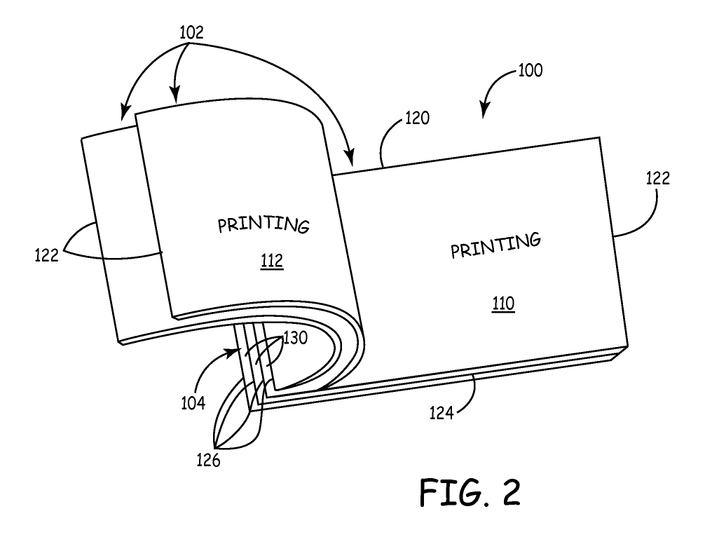

FIGS. 1-2 schematically illustrate an embodiment of a multiple page article or booklet 100. As shown, the booklet or multiple page article 100 includes a plurality of sheets 102 joined along a generally flat seam 104 to form the plurality of pages of the booklet 100. As shown in FIG. 2, the booklet 100 is opened to view the multiple pages of the booklet 100. In the embodiment shown, the plurality of sheets 102 include obverse and reverse side printing 110, 112 to form dual sided pages of the booklet 100. Although the application describes obverse and reverse side printing, application is not limited to dual sided printing and the booklet can include pages that are not printed or a combination of single and dual sided printing.

In the illustrated embodiment, the plurality of sheets 102 include edges 120, 122, 124 and 126. Each of the sheets 102 is sized so that edge surfaces 120, 122, 124 align when the sheets are arranged one on top of another. Edges 126 of the sheets 102 are staggered. In the embodiment shown, the sheets 102 have different width dimensions to form the staggered edges 126. The staggered edges 126 form a plurality of staggered flat edge surfaces 130 to adhesively connect the plurality of sheets 102 to form a seam connecting multiple pages of the multiple page article or booklet 100 as shown in FIG. 2.

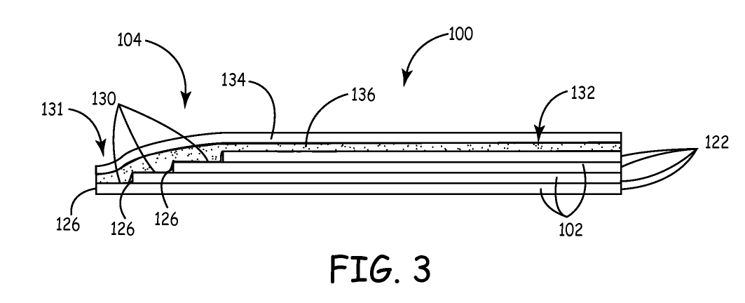

In the illustrated embodiment shown in FIG. 3, the staggered flat edges surfaces 130 are adhesively connected via an adhesive band 131 along the staggered flat edge surfaces 130. In the illustrated embodiment, the adhesive band 131 is provided as an adhesive cover layer 132 coated with adhesive. The adhesive cover layer 132 includes a clear transparent layer or portion 134 and an adhesive layer or portion 136. In an illustrated embodiment, the adhesive cover layer 132 is a clear polypropylene lamination tape. An illustrative clear polypropylene lamination tape is available from Sekisui TA Industries, Inc. of Brea, California. In the embodiment shown, the adhesive cover layer or laminate tape 132 extends between edges 122 and the staggered edges 126 of the plurality of sheets to provide a protective cover and the adhesive band 131 forming seam 104 connecting the staggered flat edges surfaces 130.

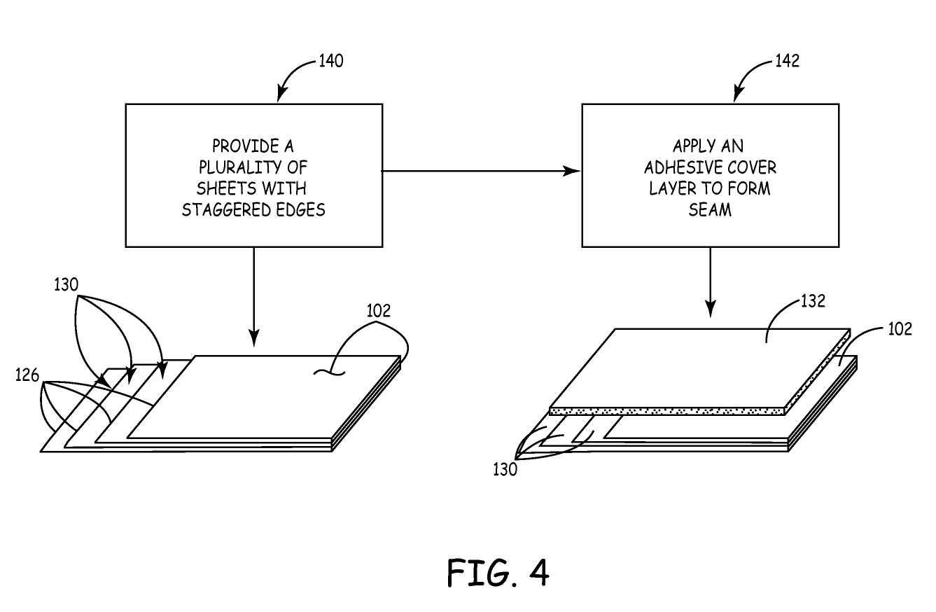

FIG. 4 illustrates process steps for fabrication of the booklet or article 100. As shown in step 140, a plurality of sheets 102 are arranged to form the plurality of staggered flat edge surfaces 130. As shown in step 142, the adhesive cover layer 132 is applied on top of the plurality of sheets 102 and the staggered flat edges surfaces 130 to form the seam 104 and the protective cover for the upper sheet. As previously described the plurality of sheets 102 include obverse and reverse side printing to form the printed pages of the booklet 100 as shown in FIG. 2. In the illustrated embodiment, the pages of the booklet 100 are printed prior to forming the seam 104 along the staggered flat edge surfaces 130.

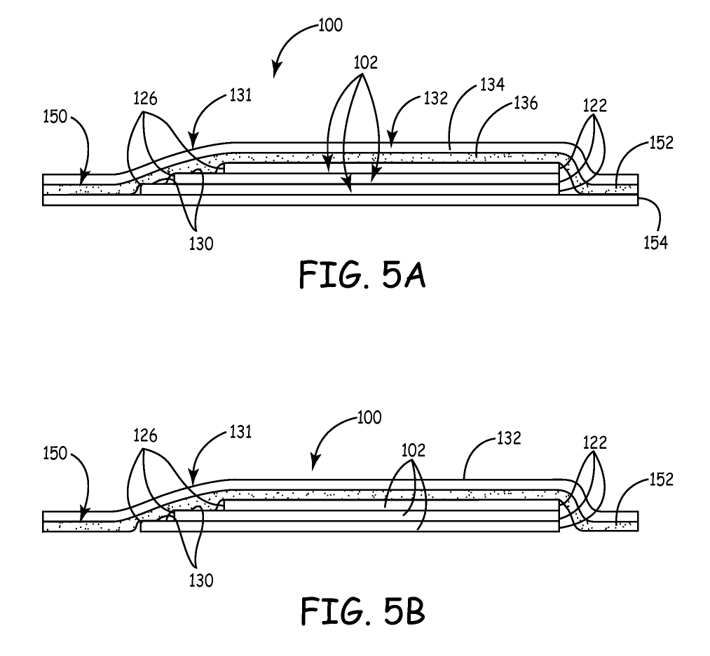

FIG. 5A illustrates an embodiment of the article or booklet 100 where like numbers are used to refer to like parts in the previous FIGS. As shown in FIG. 5A, the adhesive cover layer 132 extends beyond the staggered side edges 126 and edges 122 of the plurality of sheets 102 to form adhesive strips 150, 152 formed of a pressure sensitive adhesive along opposed sides of the booklet 100. The adhesive strips 150, 152 are used to attach the article or booklet 100 to another article or container (not shown), for example to form a label. In the illustrated embodiment, the adhesive strips 150, 152 are adhered to a releasable backing 154. In an illustrative embodiment, the releasable backing 154 is a clear film having a low surface tension so that the adhesive strips 150, 152 separate from the backing 154 to remove the booklet from the backing 154 as shown in FIG. 5B.

FIG. 5B illustrates the booklet 100 removed from the backing 154 (shown in FIG. 5A) so that the adhesive strips 150, 152 can be used to attach the multiple page booklet to the separate article or container (not shown). Once attached to the separate article or container, adhesive strip 152 is removed or peeled from the article or container to open the pages of the booklet 100. In the illustrated embodiment, adhesive strip 152 has a relatively low surface adhesion to the article or container so that the strip 152 is relatively easily removed to view the pages of the booklet. The adhesive strip 152 is reattached to close the booklet 100. As shown, the entire booklet can be removed from the article or container by peeling both adhesive strips 150, 152 to separate the booklet 100 from the article or container.

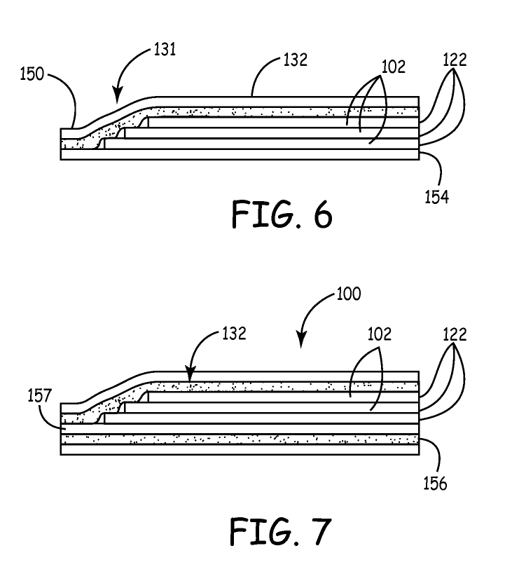

FIG. 6 illustrates another embodiment where the adhesive cover layer 132 extends beyond the staggered edges 126 to form adhesive strip 150 along the seam that can be used to attach the booklet to the article or container along one side of the booklet. FIG. 7 illustrates an embodiment where a base sheet of the booklet 100 includes an adhesive layer 156 on a reverse side of the base sheet to attach the booklet to the separate article or container (not shown). As shown, the backing layer covers to the adhesive layer prior to attachment to the article or container. The backing layer 154 is removed to attach the booklet 100 to a separate article or container (not shown). Although FIGS. 5A-5B and 6-7 illustrate several embodiments of an adhesive layer or strip application is not limited to the specific embodiments shown.

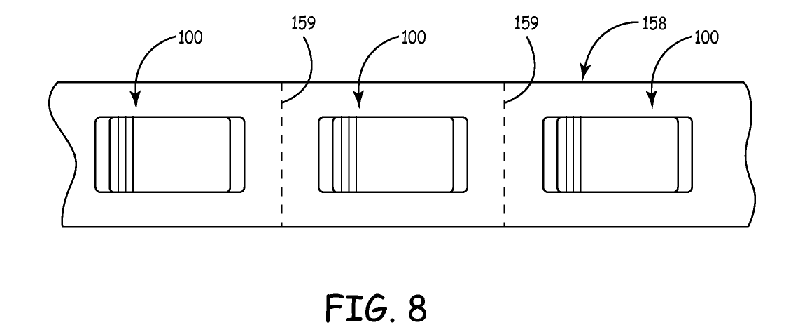

As shown in FIG. 8, a plurality of booklets can be formed along a continuous web or support 158. In illustrated embodiments, the backing layer 154 is applied to a separate web; or alternatively the backing layer 154 is integrally form as part of the web or support. In an illustrated embodiment, the web 158 includes perforations 159 to separate portions of the web containing each booklet.

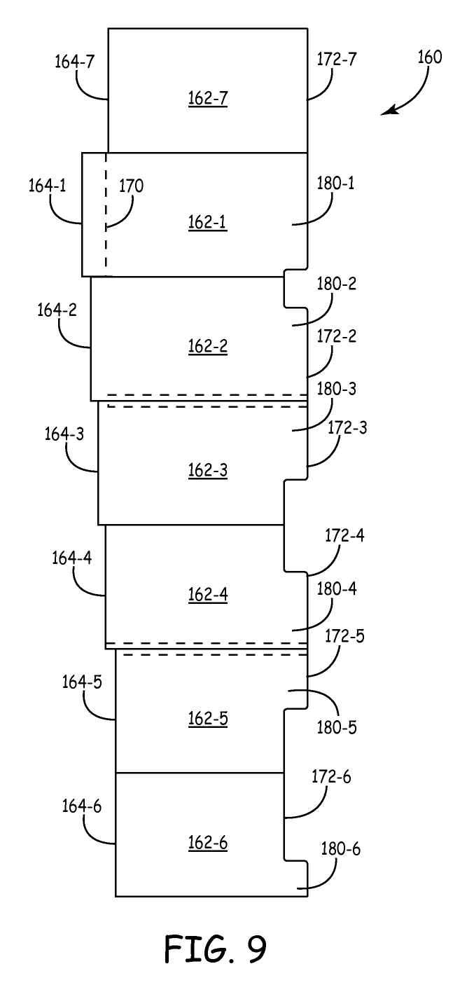

In illustrated embodiments, the plurality of sheets 102 of the booklet or article 100 are formed from an elongate foldable sheet 160, which is folded and cut to form the plurality of sheets of the booklet. FIG. 9 illustrates an embodiment of an elongate foldable sheet 160 for forming multiple pages or sheets 102 of the booklet or article 100. As shown in FIG. 9, the elongate sheet 160 includes a plurality of foldable segments 162-1 through 162-7 having staggered edge segments 164-1 through 164-7 along one side of the elongate sheet 160. The staggered edge segments 164-1 through 164-7 provide different width dimensions for the foldable segments 162-1 through 162-7 to form the staggered edges 126 of the seam 104. Although a particular number of foldable segments 162-1 through 162-7 is disclosed in the illustrated embodiment, application is not limited to any particular number of foldable segments or pages.

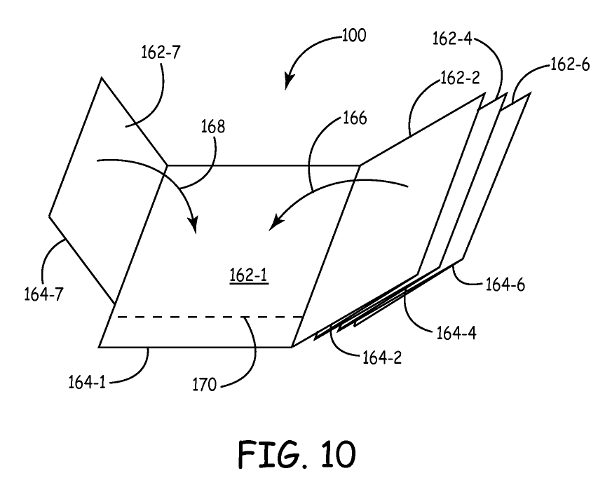

FIG. 10 illustrates a particular arrangement for the plurality of foldable segments 162-1 through 162-7. As shown, segment 162-1 forms a base segment. The side edge 164-1 of the base segment 162-1 is the most laterally spaced side edge of the staggered side edge segments 164-1 through 164-7. Foldable segments 162-2 through 162-7 are arranged to form inner foldable segments 162-2 through 162-6 and an outer foldable segment 162-7. Inner foldable segments 162-2 through 162-6 fold onto the base segment 162-1 as shown via arrow 166 in FIG. 10. The outer foldable segment 162-7 folds on top of the inner foldable segments 162-2 through 162-6 as illustrated by arrow 168 in FIG. 10.

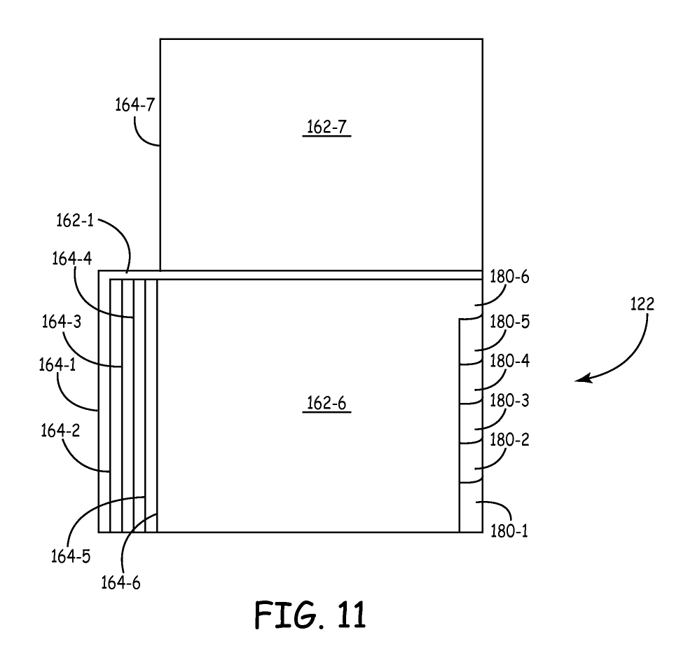

FIG. 11 illustrates the inner foldable segments 162-2 through 162-6 folded onto the base segment 162-1. The inner foldable segments 162-2 through 162-6 includes the staggered edge segment segments 164-2 through 164-6 spaced inwardly from the side edge 164-1 of the base segment 162-1. In an illustrative embodiment, the side edges 164-2 through 164-6 of each of the foldable segments 162-2 through 162-6 are successively staggered about an % of an inch inward from the side edge 164-1 of the base segment 162-1.

Inner foldable segments 162-2 through 162-6 are folded in accordion style. In particular, foldable segments 162-2 through 162-6 are folded in alternating obverse and reverse fold directions. As illustrated in FIG. 9, reverse folds are formed between foldable segments 162-2 and 162-3, 162-4 and 162-5 and obverse folds are formed between foldable segments 162-3 and 162-4, 162-5 and 162-6. As shown, obverse folds are formed between base segment 162-1 and inner foldable segment 162-2 and outer foldable segment 162-7. Inner foldable segments 162-2 through 162-6 are folded onto the base segment 162-1 as previously described and thereafter outer foldable segment 162-7 is folded on top of the inner foldable segments 162-2 through 162-6 as illustrated by arrow 168 in FIG. 10.

As previously described, in an illustrated embodiment, edge segments 164-1 through 164-7 are staggered about an % of an inch to form an % inch wide flat staggered edge surfaces 130 of the seam 104 of the booklet 100. As shown in FIGS. 9-10, the base segment 162-1 includes a perforation 170 for separation of the base segment 162-1 from the booklet 100 as desired. For example, the base segment sheet may be a printed order form or other printed document, which the user may choose to separate from the booklet 100. The perforation 170 facilitates this separation. In another embodiment, one or more sheets can be perforated for separation and application is not limited to the specific embodiment shown.

As illustrated in FIGS. 9 and 11, edges 172-2 through 172-6 of foldable segments 162-2 through 162-7 are cut to form a plurality of sequentially spaced tabs 180-1 through 180-6. As shown in FIG. 11, when the foldable segments 162-1 through 162-6 are folded, the plurality of tabs 180-1 through 180-6 are spaced along a length of edge 122 of the booklet 100.

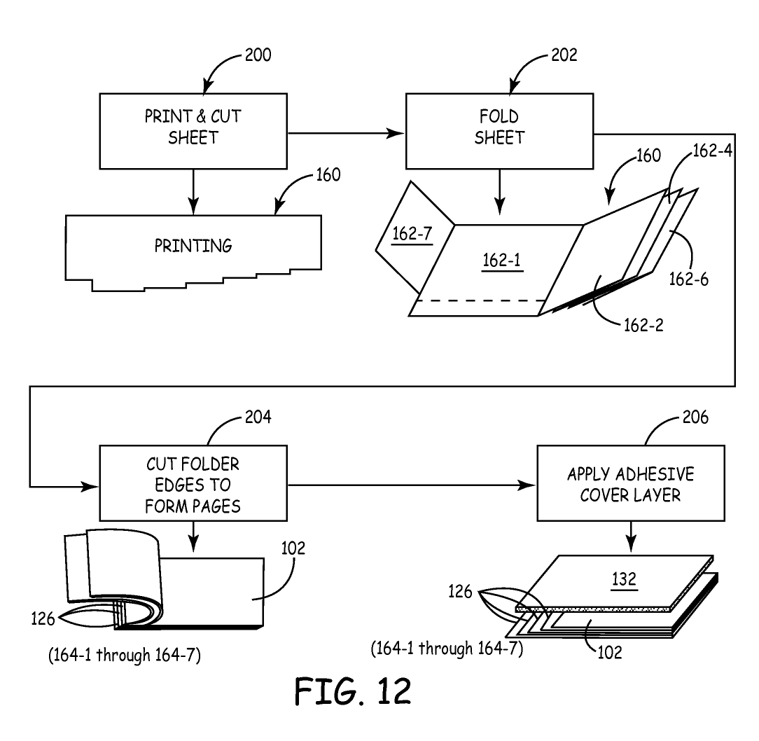

The foldable sheet 160 having the staggered side edge segments 164-1 through 164-7 is used to form the booklet as schematically illustrated in FIG. 12. As shown in step 200, the elongate foldable sheet 160 is cut to form the plurality of staggered side edge segments 164-1 through 174-7. For example, the sheet 160 is cut using know die cutting techniques. The foldable sheet 160 can be printed as described using flexigraphic printing processes as will be appreciated by those skilled in the art. As will be appreciated by those skilled in the art, the sheet 160 can be printed prior to or after cutting the sheet to form the plurality of staggered edge segments 164-1 through 164-7. In an illustrated embodiment, both sides of the foldable sheet 160 are printed to form obverse and reverse printing on pages of the booklet 100 prior to folding the elongate sheet 160 to form the plurality of foldable segments 162-1 through 162-6

In step 202 the elongate sheet 160 is folded, for example as shown in FIGS. 9-11. In illustrated embodiments, the elongate sheet 160 is machine folded. Illustrative folding machines for folding the elongate sheet 160 include Stahlfolder® folding machines from

Heidelberger Druckmaschinem AG Corp. of Heidelberg, Germany or folding machines available from MBO America, Inc. of Westampton, N.J.

Although a particular folding arrangement is shown, application is not limited to the particular embodiment shown. For example, the booklet can be formed by folding an elongate sheet in a nested fashion, where each segment is folded in a common fold direction. In the nested arrangement, the edges of the segments are arranged to provide the staggered edges surfaces 130 for the seam 104 as previously described.

In step 204, the folded sheet is cut to form the pages. The folded sheet 160 is cut to remove the folds connecting the foldable segments 162-1 through 162-7 to form the plurality of separate sheets 102 of the booklet 100. For example, in the illustrated embodiment the folded sheet 160 is cut along a top edge to remove the reverse folds of the inner foldable segments 162-2 through 162-6 and obverse fold between the outer foldable segment 162-7 and base segment 162-1. The folded sheet is also cut along a bottom edge to remove the obverse folds of inner foldable segments 162-2 through 162-6 and the fold between base segment 162-1 and foldable segment 162-2.

In step 206, the adhesive cover layer 132 is applied to the top of the cut sheets 102. The adhesive cover layer or laminate sheet 132 has sufficient width so that it coextends along the staggered edge surfaces 130 to form the seam 104 of the booklet and one or more adhesive strips as disclosed in illustrated embodiments. In illustrated embodiments, the sheets 102 of the booklet are cut and laminated along a continuous assembly line process for enhanced efficiency and to eliminate the need for separate binding and collate processes.

Although the present invention has been described with reference to preferred embodiments, workers skilled in the art will recognize that changes may be made in form and detail without departing from the spirit and scope of the invention. For example, although the application illustrates a foldable sheet having a particular fold pattern or arrangement, application is not limited to the particular foldable pattern shown. For example, a nested or alternate accordion fold pattern can be used. Also, although the application describes a particular sequence for fabrication, application is not limited to the specific order or sequences shown. For example, the adhesive cover layer can be applied prior to cutting the folded edges to form the pages as described with respect to FIG. 12.

What is claimed is:

1. A multiple page article comprising:
a plurality of sheets having a plurality of staggered side edges forming a plurality of generally flat staggered edge surfaces along at least one side of the plurality of sheets; and
an adhesive band along the staggered edge surfaces of the plurality of sheets which forms a seam connecting the plurality of sheets along the generally flat staggered edge surfaces to form the multiple page article.

2. The multiple page article of claim 1 wherein the adhesive band comprises an adhesive cover layer coated with an adhesive.

3. The multiple page article of claim 2 wherein the adhesive cover layer is generally transparent.

4. The multiple page article of claim 2 wherein the adhesive cover layer has a width that extends beyond one or more sides of the multiple page article and overhangs the one or more side of the multiple page article to form one or more adhesive strips configured to connect the multiple page article to a separate object or container.

5. The multiple page article of claim 2 wherein the adhesive cover layer has a width that overhangs opposed sides of the multiple page article to form a plurality of adhesive strips along the opposed sides configured to connect the multiple page article to a separate object or container.

6. The multiple page article of claim 1 wherein the staggered side edges of the plurality of sheets are staggered about an ⅛ inch to form the generally flat staggered edges surfaces.

7. The multiple page article of claim 1 wherein the plurality of sheets includes a first sheet having a first width between opposed sides of the first sheet and a second sheet have a second width between opposed sides of the second sheet smaller than the width between the opposed sides of the first sheet to form the staggered side edges of the plurality of sheets and the generally flat staggered edge surfaces of the seam.

8. The multiple page article of claim 1 wherein one or more of the plurality of sheets includes tabs along another side of the plurality of sheets opposite to the at least one side of the plurality of sheets having the staggered edge surfaces.

9. A method comprising:
providing one or more staggered edge surfaces formed relative to a plurality of staggered edges; and
applying an adhesive band covering the one or more staggered edge surfaces to form a seam connecting the one or more staggered edge surfaces to form a multiple page article.

10. The method comprising of claim 9 wherein the plurality of staggered edges are formed along one or more sheets and comprising:
printing material on the one or more sheets prior to applying the adhesive band.

11. The method of claim 9 and comprising:
folding an elongate sheet having a plurality of staggered edge segments to form a plurality of folded segments separated by folded edges forming the one or more staggered edge surfaces; and
cutting the folded edges to form pages of the multiple page article.

12. The method of claim 11 and comprising:
cutting the elongate sheet to form the staggered edge segments prior to folding the elongate sheet; and
folding the elongate sheet to align the staggered edge segments to form the one or more staggered edge surfaces prior to cutting the folded edges to form the pages of the multiple page article.

13. The method of claim 11 wherein the folded edges are cut prior to applying the adhesive band covering the one or more staggered edge surfaces to form the seam of the multiple page article.

14. The method of claim 11 wherein the step of folding the elongate sheet comprises:
alternately folding the elongate sheet in obverse and reverse fold directions to form the plurality of folded segments.

15. A multiple page article comprising:
a plurality of pages including a plurality of staggered edges;
one or more staggered edge surfaces formed between the plurality of staggered edges;
an adhesive band along the staggered edge surfaces forming a seam connecting the plurality of pages along the staggered edge surfaces; and
one or more adhesive strips to attach the multiple page article to another article or container.

16. The multiple page article of claim 15 wherein the one or more adhesive strips include one or more lateral strips along one or more sides of the multiple page article.

17. The multiple page article of claim 16 wherein the multiple page article includes a plurality of lateral strips including a first adhesive strip along a first side of the multiple page article and a second adhesive strip along a second side of the multiple page article opposite to the first side.

18. The multiple page article of claim 15 and comprising:
a releasable backing layer covering the one or more adhesive strips.

19. The multiple page article of claim 15 wherein the plurality of pages have different width dimensions to form the plurality of staggered edges and the one or more staggered edge surfaces.

20. The multiple page article of claim 15 wherein the adhesive band comprises a transparent cover layer coated with an adhesive and the transparent cover layer extends from the seam to a side of the multiple page article opposite to the seam.
